(19) United States
(12) Patent Application Publication
(10) Pub. No.: US 2026/0194303 A1
(43) Pub. Date: Jul. 9, 2026

(54) PRINTED-CIRCUIT-TYPE HEAT EXCHANGER HAVING IMPROVED DURABILITY, HYDROGEN STORAGE DEVICE COMPRISING SAME, AND HYDROGEN COMPRESSION DEVICE

(71) Applicant: ENERGYN INC., Hwaseong-si, Gyeonggi-do (KR)

(72) Inventor: Ihn Kee HWANG, Hwaseong-si, Gyeonggi-do (KR)

(73) Assignee: ENERGYN INC., Hwaseong-si, Gyeonggi-do (KR)

(21) Appl. No.: 19/132,794

(22) PCT Filed: Oct. 18, 2023
(86) PCT No.: PCT/KR2023/016132

§ 371 Date: May 24, 2025

(30) Foreign Application Priority Data
Nov. 30, 2022 (KR) 10-2022-0164791

(51) Int. Cl. F28D 9/00; F17C 13/00

(52) U.S. Cl. CPC F28D 9/0056; F17C 13/002; F28D 9/005; F17C 2221/012; F17C 2227/0339

(57) ABSTRACT

A printed-circuit-type heat exchanger having improved durability, includes: a first plate having a first flow path through which a first fluid passes; and a second plate overlapping the first plate so as to have a second flow path through which a second fluid passes, wherein the first plate includes: a first fluid supply hole through which the first fluid is supplied to the first flow path; a first fluid discharge hole through which the first fluid having passed through the first flow path is discharged; a first flow path integration hole, which is positioned at one end or both ends of the first flow path; and a first fluid dispersion part for connecting, to each other, the e first flow path integration hole and the first fluid supply hole or the first fluid discharge hole of a position corresponding to the first flow path integration hole.

### TECHNICAL FIELD

The present invention relates to a printed-circuit-type heat exchanger configured to perform heat exchange between a first fluid and a second fluid through different flow paths by stacking a plurality of plates on each other, a hydrogen storage device including the heat exchanger, and a hydrogen compression device including the heat exchanger.

### BACKGROUND ART

In general, a heat exchanger serves as a device configured to perform heat exchange between a first fluid and a second fluid and has a structural configuration in which respective flow paths allowing the first fluid and the second fluid to flow therethrough without mixing are formed in respective plates using a press, and the plates are alternately stacked on each other.

Such a plate-type heat exchanger has a protruding shape because each of the flow paths is pressed by the press, leading to an increase in volume. Further, when the fluid is supplied at a relatively high pressure, leakage of the fluid easily occurs in the plate-type heat exchanger.

In order to address the above-described problem, a “heat exchanger” is disclosed in JP 2000-161889 A (filed on Jun. 16, 2000).

The heat exchanger described above is configured to form grooves in plates to be stacked on each other without protrusion of a flow path, and the plates are completely bonded to each other, thereby making it possible not only to supply a high-pressure fluid, but also to prevent leakage of the fluid from the heat exchanger.

However, in the conventional heat exchangers, when a high-pressure fluid undergoes heat exchange with another fluid, a large amount of fluid may not be supplied because the diameter of a fluid supply passage needs to be reduced, so it takes a long time to complete heat exchange. Further, when a high-pressure fluid is supplied in a state in which the size of the fluid supply passage is constantly maintained, the thickness of an end plate configured to seal the end portion of the fluid supply passage needs to be increased, resulting in an increase in the weight and volume of the heat exchanger.

In addition, in order to increase a flow path through which fluid flows, the flow path may be formed to have a zigzag pattern. However, in this case, there is a problem in that, while fluid flows through a flow path, heat of the fluid flowing through the flow path is transferred to fluid flowing through another flow path adjacent thereto, leading to deterioration in heat exchange properties of the fluid.

### DISCLOSURE

### Technical Problem

Therefore, the present invention has been made in view of the above problems, and it is an object of the present invention to provide a printed-circuit-type heat exchanger having improved durability, configured to allow a first fluid introduced into a first fluid supply hole to be dispersed through a fluid dispersion part and flow into a first flow path integration hole, thereby enabling a large amount of the first fluid to quickly exchange heat with another fluid in a state in which the first fluid introduced into the first fluid supply hole is dispersed and supplied, a hydrogen storage device including the heat exchanger, and a hydrogen compression device including the heat exchanger.

It is another object of the present invention to provide a printed-circuit-type heat exchanger having improved durability and providing a structural configuration in which the diameter of a first flow path integration hole is formed to be larger than the diameter of a first fluid supply hole so as to increase a connection area with a first flow path, thereby supplying a large amount of a first fluid to the first flow path, a hydrogen storage device including the heat exchanger, and a hydrogen compression device including the heat exchanger.

It is a still further object of the present invention to provide a printed-circuit-type heat exchanger having improved durability and providing a structural configuration in which a first fluid dispersion part and a communication dispersion part are bonded to each other and are located in the center of a first fluid supply passage configured for a first fluid to be supplied therethrough, thereby having an effect of forming a shape similar to a support column erected in the center of the first fluid supply passage and reliably withstanding the pressure of the first fluid supply passage so as to improve durability of the heat exchanger, a hydrogen storage device including the heat exchanger, and a hydrogen compression device including the heat exchanger.

It is a yet further object of the present disclosure to provide a printed-circuit-type heat exchanger having improved durability and providing a structural configuration in which a first fluid dispersion part and a communication dispersion part are bonded to an end plate, and a central portion of a first fluid supply passage is bonded to the end plate, thereby preventing expansion of the end plate due to the pressure of a first fluid and reducing the weight and size of the heat exchanger through reduction in thickness of the end plate, a hydrogen storage device including the heat exchanger, and a hydrogen compression device including the heat exchanger.

It is an even further object of the present disclosure to provide a printed-circuit-type heat exchanger having improved durability and providing a structural configuration in which a thermal insulation part is formed between a first direction part and a second direction part respectively having different first fluid flow directions in a first flow path so as to prevent heat transfer between the first fluids adjacent to each other, thereby improving heat exchange properties of the first fluid, a hydrogen storage device including the heat exchanger, and a hydrogen compression device including the heat exchanger.

It is an even further object of the present disclosure to provide a printed-circuit-type heat exchanger having improved durability and providing a structural configuration in which an integration hole reinforcing part is formed to protrude from a second flow path integration hole connected to a second flow path and is bonded to a first plate, thereby reinforcing rigidity through formation of the second flow path integration hole having a large width, and a second fluid flows through a space between layers of the plates through an interlayer connection part in the second fluid through-hole such that the second fluid flows through second flow path integration holes respectively formed in a second fluid supply hole and a second fluid discharge hole, thereby reliably supplying a large amount of the second fluid, a hydrogen storage device including the heat exchanger, and a hydrogen compression device including the heat exchanger.

### Technical Solution

In accordance with an aspect of the present invention, the above and other objects can be accomplished by the provision of a printed-circuit-type heat exchanger having improved durability, the printed-circuit-type heat exchanger including a first plate having a first flow path formed therein and configured for a first fluid to flow therethrough, and a second plate overlapping the first plate, the second plate having a second flow path formed therein and configured for a second fluid to flow therethrough, wherein the first plate includes a first fluid supply hole configured for the first fluid to be supplied therethrough to the first flow path, a first fluid discharge hole configured for the first fluid passing through the first flow path to be discharged therefrom, a first flow path integration hole located in one end or both ends of the first flow path, the first flow path integration hole being configured to integrally connect channels of the first flow path to each other so as to supply the first fluid to the first flow path or to discharge the first fluid from the first flow path, a first fluid dispersion part configured to connect the first flow path integration hole to the first fluid supply hole or the first fluid discharge hole formed at a location corresponding to the first flow path integration hole, the first fluid dispersion part being configured for the first fluid to be dispersed and moved therethrough.

The first flow path integration hole may be formed to have a larger diameter than a diameter of the first fluid supply hole or the first fluid discharge hole such that a large number of the channels of the first flow path are connected to the first fluid supply hole or the first fluid discharge hole.

The second plate may include a communication integration hole formed to pass therethrough, and the communication integration hole may be formed at a location corresponding to the first flow path integration hole in a state of overlapping the first flow path integration hole so as to allow the first fluid in the first flow path integration hole to move through the second plate.

The first flow path integration hole and the communication integration hole may be disposed in opposite directions with respect to the first fluid supply hole or the first fluid discharge hole such that, when the first fluid flows through the first plate and the second plate in a direction in which the first plate and the second plate are stacked on each other, the first fluid alternately flows through one side and the other side of the first fluid supply hole or the first fluid discharge hole.

The second plate may include first fluid through-holes respectively formed at locations corresponding to the first fluid supply hole and the first fluid discharge hole, the first fluid through-holes being configured for the first fluid to pass through the second plate in a direction in which the first plate and the second plate are stacked on each other, and a communication dispersion part formed between the first fluid through-hole and the communication integration hole and configured to allow the first fluid to be dispersed and moved between the first fluid through-hole and the communication integration hole.

The first fluid dispersion part may include a circumferential dispersion flow path located between the first fluid supply hole and the flow path integration hole or between the first fluid discharge hole and the flow path integration hole, the circumferential dispersion flow path being formed to have a larger circumference than a circumference of the first fluid supply hole or the first fluid discharge hole, an inner connection flow path configured to connect the circumferential dispersion flow path to the first fluid supply hole or the first fluid discharge hole corresponding to the circumferential distribution flow path, and an outer connection flow path configured to connect the circumferential dispersion flow path to the flow path integration hole corresponding to the circumferential distribution flow path.

The first flow path or the second flow path may include a first direction part and a second direction part disposed adjacent to each other, the first and second direction parts respectively having different flow directions of the first fluid or the second fluid, and a thermal insulation part formed to penetrate a portion located between the first direction part and the second direction part so as to block heat transfer therebetween.

The thermal insulation part may include a connection reinforcing part formed to cross the thermal insulation part so as to reinforce rigidity reduced by the thermal insulation part formed to penetrate the portion between the first direction part and the second direction part.

The first plate and the second plate may be fully bonded to each other by diffusion bonding.

One of the first fluid and the second fluid may be refrigerant, and the other may contain hydrogen cooled by the refrigerant.

The first flow path in the first plate or the second flow path in the second plate may be formed by chemical etching or mechanical polishing.

The printed-circuit-type heat exchanger may further include an end plate stacked on the first plate or the second plate located on an outermost side of the first plate and the second plate stacked on each other, the end plate sealing the fluid supply hole and the fluid discharge hole, and the first fluid dispersion part may be bonded to the end plate so as to improve durability of a portion of the end plate part, the portion corresponding to the first fluid supply hole or the first fluid discharge hole.

The first plate or the second plate may include a weight reduction hole for reduction in weight of the first plate or the second plate, the weight reduction hole being formed by perforating the first plate or the second plate.

Each of the first plate and the second plate stacked on each other may include a rod installation hole formed therein and configured for a fixing rod to be inserted thereinto so as to fix the stacked first and second plates.

In accordance with another aspect of the present invention, there is provided a printed-circuit-type heat exchanger having improved durability, the printed-circuit-type heat exchanger including a first plate having a first flow path formed therein and configured for a first fluid to flow therethrough, and a second plate overlapping the first plate, the second plate having a second flow path formed therein and configured for a second fluid to flow therethrough, wherein the second plate includes second flow path integration holes connected to channels of the second flow path so as to communicate therewith, a second fluid supply hole and a second fluid discharge hole respectively spaced apart from the second flow path integration holes respectively located in both ends of the second flow path, the second fluid supply hole being configured for the second fluid to be supplied therethrough, the second fluid discharge hole being configured for the second fluid to be discharged therethrough, and integration hole reinforcing parts formed to protrude from the respective second flow path integration holes, the integration hole reinforcing parts being bonded to the first plate so as to reinforce rigidity reduced by formation of the second flow path integration holes, and wherein the first plate includes second fluid through-holes respectively formed at locations respectively corresponding to the second fluid supply hole and the second fluid discharge hole, each of the second fluid through-holes being configured for the second fluid to pass therethrough, and interlayer connection parts formed to extend from the respective second fluid through-holes, wherein one of the interlayer connection parts is connected to the second flow path integration hole corresponding to the second fluid supply hole, and the other of the interlayer connection parts is connected to the second flow path integration hole corresponding to the second fluid discharge hole, thereby enabling a large amount of the second fluid to flow through a space between layers of the first and second plates.

In accordance with still another aspect of the present invention, there is provided a hydrogen storage device including a printed-circuit-type heat exchanger having improved durability, the hydrogen storage device including the printed-circuit-type heat exchanger having improved durability, and a hydrogen tank configured to store hydrogen therein, the hydrogen being cooled by the printed-circuit-type heat exchanger, or to supply the stored hydrogen to the printed-circuit-type heat exchanger for cooling.

In accordance with a further aspect of the present invention, there is provided a hydrogen compression device including a printed-circuit-type heat exchanger having improved durability, the hydrogen compression device including the printed-circuit-type heat exchanger having improved durability, and a compressor configured to receive hydrogen cooled through the printed-circuit-type heat exchanger and compress the cooled hydrogen, or to compress the hydrogen and supply the compressed hydrogen to the printed-circuit-type heat exchanger.

### Advantageous Effects

According to the present invention, a first fluid introduced into a first fluid supply hole is dispersed through a fluid dispersion part and flows into a first flow path integration hole, thereby enabling a large amount of the first fluid to quickly exchange heat with another fluid in a state in which the first fluid is dispersed and supplied into the first fluid supply hole and the first flow path integration hole.

Additionally, the diameter of the first flow path integration hole is formed to be larger than the diameter of the first fluid supply hole so as to increase a connection area with the first fluid, thereby supplying a large amount of the first fluid to a first flow path and allowing the first fluid to quickly exchange heat with another fluid.

Furthermore, a first fluid dispersion part and a communication dispersion part are bonded to each other and are located in a central portion of a first fluid supply passage, thereby having an effect of forming a shape similar to a support column erected in the center of the first fluid supply passage and improving durability of the first fluid supply passage.

In addition, the first fluid dispersion part and the communication dispersion part are bonded to an end plate, and the central portion of the first fluid supply passage is bonded to the end plate, thereby having an effect of preventing expansion of the end plate due to the pressure of the first fluid and reducing the weight and size of the heat exchanger through reduction in thickness of the end plate.

A thermal insulation part is formed to penetrate a portion between a first direction part and a second direction part respectively having different first fluid flow directions in the first flow path so as to prevent heat transfer between the first fluids adjacent to each other in the first flow path, thereby having an effect of improving heat exchange properties of the first fluid.

Further, an integration hole reinforcing part is formed to protrude from a second flow path integration hole connected to a second flow path and is bonded to a first plate, thereby reinforcing rigidity through formation of the second flow path integration hole having a relatively large width, and a second fluid flows through a space between layers of the plates through an interlayer connection part in the second fluid through-hole such that the second fluid flows through second flow path integration holes respectively formed in a second fluid supply hole and a second fluid discharge hole, thereby having an effect of reliably supplying a large amount of the second fluid.

### DESCRIPTION OF DRAWINGS

FIG. 1 is a partially exploded perspective view of a printed-circuit-type heat exchanger having improved durability according to an embodiment of the present invention;

FIG. 2 is a plan view of a first plate of the printed-circuit-type heat exchanger having improved durability according to the embodiment of the present invention;

FIG. 3 is a plan view of a second plate of the printed-circuit-type heat exchanger having improved durability according to the embodiment of the present invention;

FIG. 4 is a perspective view showing a portion at which a first fluid supply hole and a first fluid through-hole of the printed-circuit-type heat exchanger having improved durability according to the embodiment of the present invention are located;

FIG. 5 is a plan view showing the portion at which the first fluid supply hole and the first fluid through-hole of the printed-circuit-type heat exchanger having improved durability according to the embodiment of the present invention are located;

FIG. 6 is a side cross-sectional view showing the portion at which the first fluid supply hole and the first fluid through-hole of the printed-circuit-type heat exchanger having improved durability according to the embodiment of the present invention are located;

FIG. 7 is a plan view showing a portion at which a second fluid supply hole and a second fluid through-hole of the printed-circuit-type heat exchanger having improved durability according to the embodiment of the present invention are located; and

FIG. 8 is a plan view showing the portion at which the second fluid supply hole and the second fluid through-hole of the printed-circuit-type heat exchanger having improved durability according to the embodiment of the present invention are located.

### BEST MODE

Hereinafter, an embodiment of the present invention will be described with reference to the accompanying drawings.

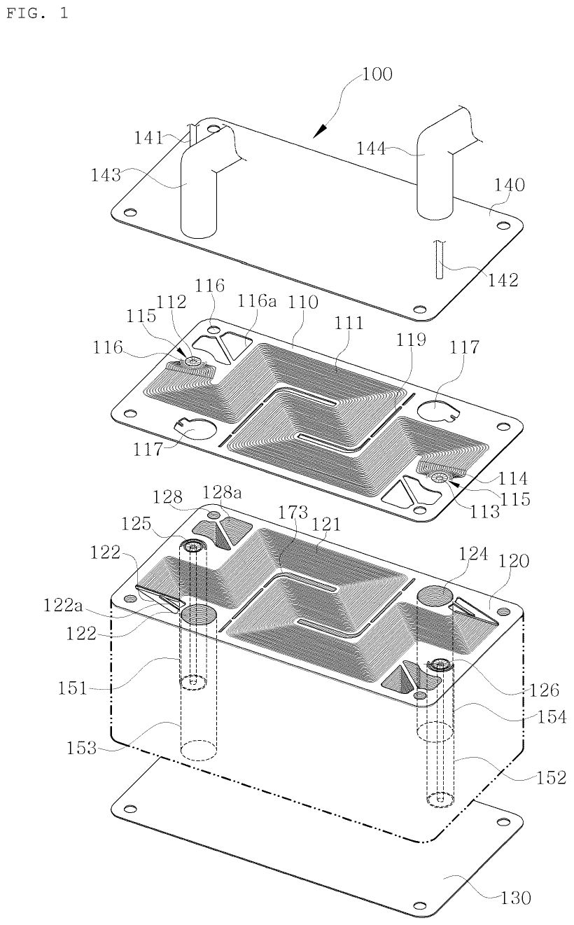

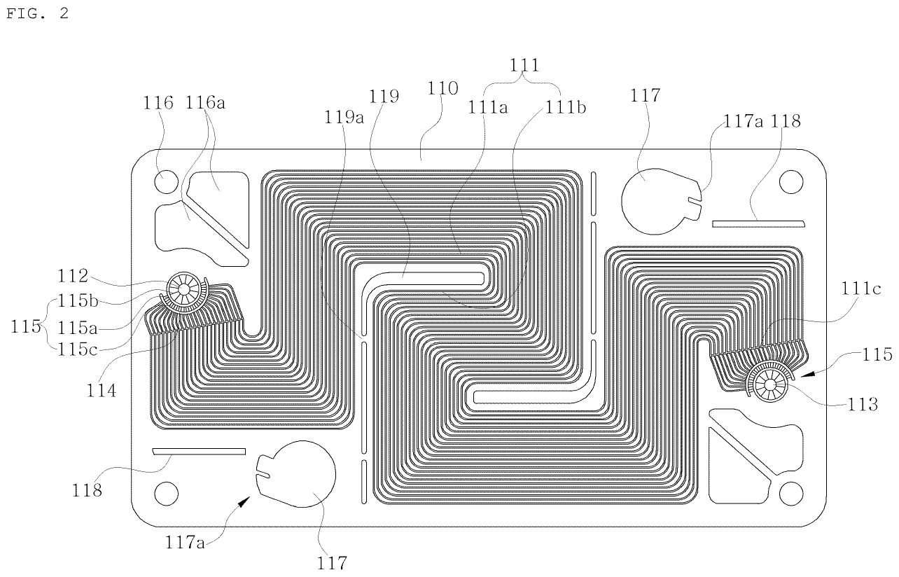

As shown in FIGS. 1 and 2, a printed-circuit-type heat exchanger 100 having improved durability according to an embodiment of the present invention may include a first plate 110.

The first plate 110 and a second plate 120 may be alternately stacked on each other to form the heat exchanger 100, and an intermediate plate may be further installed between the first plate 110 and the second plate 120 so as to expand the area of a first flow path 111 formed in the first plate or the area of a second flow path 121 formed in the second plate.

The first plate 110 may be formed as a flat plate and may have the first flow path 111 formed therein and configured for a first fluid to pass therethrough.

Here, the first fluid or a second fluid may be gas or liquid. In the embodiment, although it is described that the first fluid is hydrogen, and the second fluid is a heat medium for cooling hydrogen, the first fluid may be a heat medium, and the second fluid may be hydrogen.

Of course, the heat medium may cool or heat hydrogen depending on the temperature.

The first plate 110 may be formed of a metallic material having excellent heat exchange properties. The first plate 110 may be formed of a material having excellent heat exchange properties and resistance to the fluid flowing through the first flow path 111, such as corrosion resistance and hydrogen embrittlement resistance.

The first flow path 111 formed in the first plate 110 may be formed in a such a manner that a groove is formed in one surface of the first plate 110, and the flow path in the first plate 110 may be formed by chemical etching or mechanical polishing.

Here, when the first flow path 111 is formed in the first plate 110 by chemical etching or mechanical polishing, a relatively fine flow path may be formed, thereby improving heat exchange performance between the fluids exchanging heat with each other.

The first flow path 111 may have a configuration in which multiple channels are arranged in parallel so as to allow the first fluid to be dispersed and moved in multiple directions.

In the first plate 110, the first flow path 111 may be formed to have a zigzag shape so as to increase a distance for heat exchange while the first fluid flows through the first flow path. Further, the first flow path 111 may be formed to have a zigzag shape in such a manner that a first direction part 111a and second direction part 111b respectively having different first fluid flow directions are continuously and alternately arranged.

The first plate 110 may have a thermal insulation part 119 formed to penetrate a portion between the first direction part 111a and the second direction part 111b and configured to thermally insulate the first direction part 111a and the second direction part 111b so as to prevent the heat of the first fluid flowing through the first direction part 111a from being transferred to the first fluid flowing through the adjacent second direction part 111b.

For example, in a case where the first direction part 111a and the second direction part 111b are arranged adjacent to each other in the first flow path 111, when the heat of the first fluid flowing through the first direction part 111a is transferred to the second direction part 111b, or the heat of the second direction part 111b is transferred to the first direction part 111a, heat exchange properties of the first fluid that has moved a long distance and has exchanged heat with the second fluid may deteriorate. For this reason, the thermal insulation part 119 is provided to secure thermal insulation between the first direction part 111a and the second direction part 111b and is formed by cutting a portion located between the first direction part 111a and the second direction part 111b arranged adjacent to each other, thereby maximally reducing heat transfer between the first direction part 111a and the second direction part 111b arranged adjacent to each other.

In the thermal insulation part 119, a connection reinforcing part 119a may be formed to cross the thermal insulation part 119 so as to improve durability of the first plate 110 having the thermal insulation part 119 formed by penetrating a portion of the first plate 110.

A plurality of connection reinforcing part 119a may be formed in the thermal insulation part 119 so as to divide the thermal insulation part 119 into a plurality of parts.

The first plate 110 may have a rod installation hole 116 formed to penetrate each corner portion thereof and configured for a fixing rod to be inserted thereinto so as to fix the first plate 110 and the second plate 120 alternately stacked on each other.

The fixing rod is inserted into the rod installation hole 116 to fixedly press the first plate 110 and the second plate 120 in the stacked direction of the first and second plates, thereby preventing separation of the first plate 110 and the second plate 120 stacked on each other.

The first plate 110 may include a first fluid supply hole 112 and a first fluid discharge hole 113.

The first fluid supply hole 112 is formed to penetrate one end of the first flow path 111. When the first fluid is supplied to the first flow path 111, the first fluid may be supplied through the first fluid supply hole.

The first fluid discharge hole 113 is formed in the other end of the first flow path 111. Here, the other end of the first flow path 111 is located in a direction opposite to a direction in which the one end of the first flow path 111, which has the first fluid supply hole 112 formed therein, is located. Accordingly, the first fluid that has been supplied to the first flow path 111 and has exchanged heat with the second fluid may be discharged through the first fluid discharge hole 113.

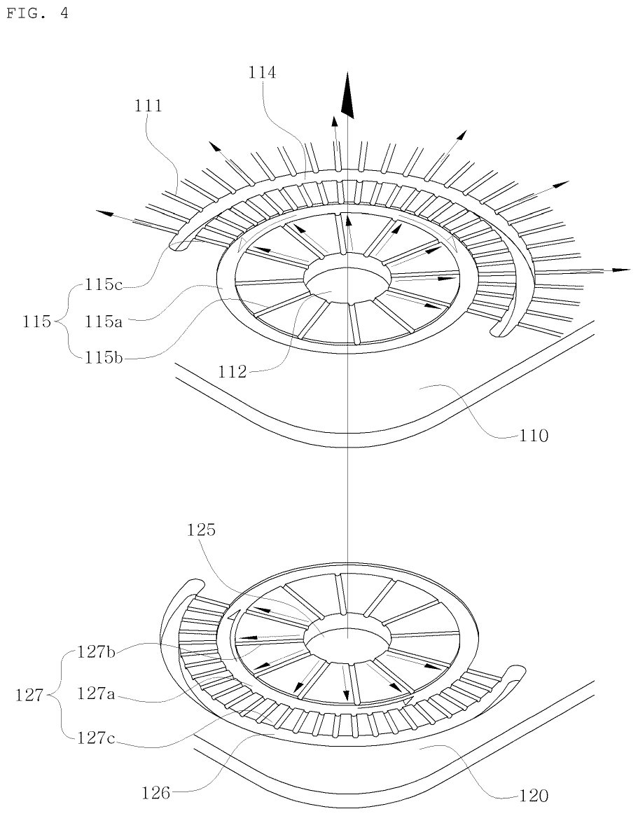

As shown in FIG. 2, FIG. 4 to FIG. 6, the first plate 110 may include a first flow path integration hole 114 and a first fluid dispersion part 115.

The first flow path integration holes 114 are formed by respectively passing through one end and the other end of the first flow path 111 of the first plate 110 so as to disperse the first fluid and supply the same to each channel of the first flow path 111, or the first fluid that has passed through each channel of the first flow path 111 may be collected in the first flow path integration holes 114.

For example, the first flow path integration hole 114 located close to the first fluid supply hole 112 is connected to one end of the first flow path 111 such that the first fluid to be supplied into the first fluid supply hole 112 flows through the first flow path integration holes 114, and the first fluid is dispersed and supplied to each channel of the first flow path 111 through the first flow path integration hole 114. Further, the first flow path integration hole 114 located close to the first fluid discharge hole 113 is connected to the other end of the first flow path 111 such that the first fluid that has passed through each channel of the first flow path 111 is collected in the first flow path integration hole 114, and then the first fluid in the first flow path integration hole 114 is moved again to the first fluid discharge hole 113 and is discharged through the first fluid discharge hole 113.

Here, when the first fluid having a high pressure is supplied into the first fluid supply hole 112, the first fluid supply hole 112 may not be formed to have a large diameter to secure durability. As a result, there is a problem in that heat exchange performance deteriorates because a large amount of the first fluid is not supplied to the first flow path 111.

Accordingly, in the present invention, since the first flow path integration hole 114 is formed at a location adjacent to the first fluid supply hole 112, a space to supply the first fluid to the first flow path 111 may be expanded, and a large amount of the first fluid may be supplied to the first flow path 111 compared to the relatively small first fluid supply hole 112, thereby improving heat exchange performance and preventing deterioration in durability.

In addition, resistance according to movement of the first fluid may be increased by the first fluid dispersion part 115 and a communication dispersion part 127, and thus the pressure of the first fluid passing through the first flow path integration hole 114 and a communication integration hole 126 may be reduced, thereby improving durability of the heat exchanger.

Meanwhile, the first flow path integration hole 114 may be formed to have a larger diameter than that of the first fluid supply hole 112 or the first fluid discharge hole 113 so as to allow more first fluid to be dispersed and introduced into the first fluid supply hole 112 or to allow more fluid to be discharged through the first fluid discharge hole 113, and the first fluid discharge hole 113 may be formed to have an arc shape on the concentric circle of the first fluid discharge hole 113 and the first fluid supply hole 112.

Here, when the first fluid is supplied at a high pressure, each of the first fluid supply hole 112 and the first fluid discharge hole 113 needs to have a small diameter, so that it is difficult to connect a large number of channels of the first flow path 111 to the first fluid supply hole 112 and the first fluid discharge hole 113. However, since the first flow path integration hole 114 is formed to have a larger diameter than that of the first fluid supply hole 112 or the first fluid discharge hole 113, a large number of channels of the first flow path 111 may be connected to the first fluid supply hole 112 and the first fluid discharge hole 113, thereby supplying a large amount of the first fluid.

The first fluid dispersion parts 115 may be respectively formed at a portion between the first fluid supply hole 112 and the adjacent first flow path integration hole 114 and a portion between the first fluid discharge hole 113 and the adjacent first flow path integration hole 114, thereby dispersing the first fluid to be supplied into the first fluid supply hole 112 and supplying the dispersed first fluid into the first flow path integration hole 114, or collecting the first fluid to be discharged through the first flow path integration hole 114 via the first flow path 111 and supplying the collected first fluid into the first fluid discharge hole 113.

The first fluid dispersion part 115 may radially disperse the first fluid to be supplied into the first fluid supply hole 112 and provides the dispersed first fluid into the first flow path integration hole 114 located in one end of the first flow path 111, or may collect the first fluid that has passed through the first flow path 111 and has exchanged heat with another fluid in the first flow path integration hole 114 located in the other end of the first flow path 111. Thereafter, the first fluid dispersion part 115 may collect the first fluid in the first flow path integration hole 114 again and may supply the collected first fluid into the first fluid discharge hole 113.

In the embodiment, although it is described that the first fluid dispersion parts 115 are respectively formed at a location between the first flow path integration hole 114 and the first fluid supply hole 112 that are provided in one end of the first flow path 111 and a location between the first flow path integration hole 114 and the first fluid discharge hole 113 that are provided in the other end of the first flow path 111, but the first fluid dispersion part 115 may be only formed at one of the two locations.

The first fluid dispersion part 115 may disperse the first fluid with a time difference and may provide the dispersed first fluid from the first fluid supply hole 112 to the first flow path integration hole 114 located in one end of the first flow path 111. Further, the first fluid dispersion part 115 may collect the first fluid discharged through the first flow path integration hole 114 located in the other end of the first flow path 111 with a time difference and may supply the collected first fluid into the first fluid discharge hole 113.

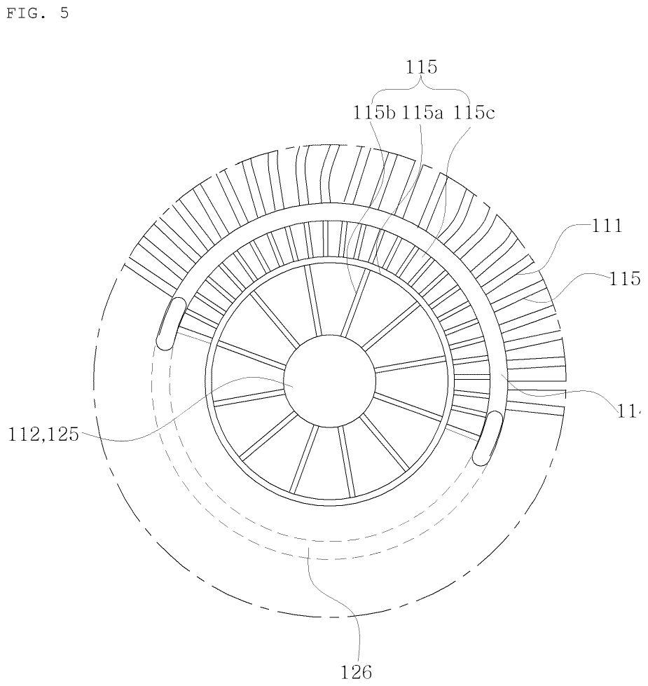

As shown in FIGS. 4 and 5, the first fluid dispersion part 115 may include a circumferential dispersion flow path 115a, an inner connection flow path 115b, and an outer connection flow path 115c.

The circumferential dispersion flow path 115a may be formed to have a circular groove shape with a larger diameter than that of the first fluid supply hole 112 or the first fluid discharge hole 113.

The inner connection flow path 115b may connect the first fluid supply hole 112 or the first fluid discharge hole 113 around which the circumferential dispersion flow path 115a is formed to the circumferential dispersion flow path 115a disposed at a location corresponding thereto so as to send the fluid supplied into the first fluid discharge hole 113 to the first fluid supply hole 112 or to collect the fluid of the circumferential dispersion flow path 115a and send the collected fluid to the first fluid discharge hole 113.

The inner connection flow path 115b may be formed to have a plurality of straight grooves radially formed in the inner circumference of the circumferential dispersion flow path 115a.

The outer connection flow path 115c may connect the circumferential dispersion flow path 115a to the first flow path integration hole 114 that is adjacent to the circumferential dispersion flow path 115a to supply the first fluid dispersed in the circumferential dispersion flow path 115a into the first flow path integration hole 114, or to supply the first fluid in the first flow path integration hole 114 to the circumferential dispersion flow path 115a.

The outer connection flow path 115c may also be formed to have a plurality of straight grooves radially formed in the outer circumference of the circumferential dispersion flow path 115a.

In this case, the inner connection flow path 115b or the outer connection flow path 115c may be located in plural only within a preset angular range on the inner or outer circumference of the circumferential dispersion flow path 115a.

The first flow path 111 may include a connection flow path part 111c.

The connection flow path part 111c may connect a plurality of channels to each other so as to allow the fluid introduced into the first flow path integration hole 114 to be supplied to each channel of the first flow path 111 at a constant pressure, or to allow the fluid discharged from each channel of the first flow path 111 to be supplied into the first flow path integration hole 114 at a constant pressure.

The connection flow path parts 111c may be formed to have a groove shape that crosses a plurality of channels in a straight line and may be respectively located at a portion between the first flow path integration hole 114 located in one end of the first flow path 111 and the first flow path 111, and a portion between the first flow path integration hole 114 located in the other end of the first flow path 111 and the first flow path 111.

The first plate 110 may have a weight reduction hole formed to penetrate an unused portion thereof and configured to reduce the weight of the first plate 110.

When the weight reduction hole is formed to have a large area, a reinforcing connection part may be formed across the weight reduction hole to reinforce rigidity of the first plate.

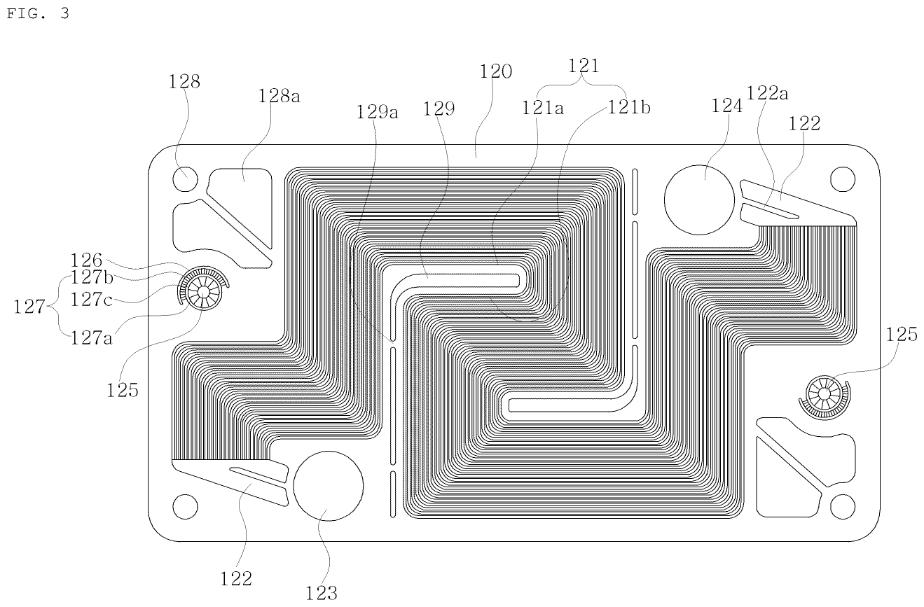

As shown in FIGS. 1 and 3, the printed-circuit-type heat exchanger 100 having improved durability according to the embodiment of the present invention may include a second plate 120.

The second plate 120 may be formed as a flat plate having a size corresponding to that of the first plate 110, and may have a second flow path 121 formed therein and configured for the second fluid to flow therethrough.

Here, the second fluid may be gas or liquid, and the second fluid may be a heat exchange medium that has been preheated or cooled to cool or heat the first fluid.

The second plate 120 may be formed of a metallic material having excellent heat exchange properties. Further, the second plate 120 may be formed of a material having excellent heat exchange properties and resistance to the fluid flowing through the second flow path 121, such as corrosion resistance and hydrogen embrittlement resistance.

The second flow path 121 formed in the second plate 120 may be formed in such a manner that a groove is formed in one surface of the second plate 120, and the flow path in the second plate 120 may be formed by chemical etching or mechanical polishing.

Here, when the second flow path 121 is formed in the second plate 120 by chemical etching or mechanical polishing, a fine flow path may be formed, thereby improving heat exchange performance between the fluids exchanging heat with each other.

The second flow path 121 may have a configuration in which multiple channels are arranged in parallel so as to allow the second fluid to be dispersed and moved in multiple directions.

In the second plate 110, the second flow path 121 may be formed to have a zigzag shape so as to increase a distance for heat exchange while the second fluid flows through the second flow path. Further, the second flow path 121 may be formed to have a zigzag shape in such a manner that a first direction part 121a and a second direction part 121b respectively having different second fluid flow directions are continuously and alternately arranged.

Here, the second flow path 121 may be formed in the second plate 120 at a location corresponding to the first flow path 111 and may have a flow path corresponding to the first flow path 111.

The second plate 120 may have a thermal insulation part 129 formed to penetrate a portion between the second direction part 121a and the second direction part 121b and configured to thermally insulate the first direction part 121a and the second direction part 121b so as to prevent the heat of the second fluid flowing through the first direction part 121a from being transferred to the second fluid flowing through the adjacent second direction part 121b.

For example, in a case where the first direction part 121a and the second direction part 121b are arranged adjacent to each other in the second flow path 121, when the heat of the second fluid flowing through the first direction part 121a is transferred to the second direction part 121b, or the heat of the second direction part 121b is transferred to the first direction part 121a, heat exchange properties of the second fluid that has moved a long distance and has exchanged heat with the first fluid may deteriorate. For this reason, the thermal insulation part 129 is provided to secure thermal insulation between the first direction part 121a and the second direction part 121b and is formed by cutting a portion located between the first direction part 121a and the second direction part 121b arranged adjacent to each other, thereby maximally reducing heat transfer between the first direction part 121a and the second direction part 121b arranged adjacent to each other.

In the thermal insulation part 129, a connection reinforcing part 129a may be formed to cross the thermal insulation part 129 so as to improve durability of the second plate 120 having the thermal insulation part 129 formed by penetrating a portion of the second plate 120.

A plurality of connection reinforcing parts 129a may be formed in the thermal insulation part 129 so as to divide the thermal insulation part 129 into a plurality of parts.

The second plate 120 may have a rod installation hole 128 formed to penetrate each corner portion thereof and configured for a fixing rod to be inserted thereinto so as to fix the first plate 110 and the second plate 120 alternately stacked on each other.

The fixing rod is inserted into the rod installation hole 128 to fixedly press the first plate 110 and the second plate 120 in the stacked direction of the first and second plates, thereby preventing separation of the first plate 110 and the second plate 120 stacked on each other.

The second plate 110 may include a first fluid supply hole 123 and a first fluid discharge hole 124.

The second fluid supply hole 123 is formed to penetrate one end of the second flow path 121. When the second fluid is supplied to the second flow path 121, the second fluid may be supplied through the second fluid supply hole.

The second fluid discharge hole 124 is formed in the other end of the second flow path 121. Here, the other end of the second flow path 121 is located in a direction opposite to a direction in which the one end of the second flow path 121, which has the second fluid supply hole 123 formed therein, is located. Accordingly, the second fluid that has been supplied to the second flow path 121 and has exchanged heat with the first fluid may be discharged through the second fluid discharge hole.

The second plate 120 may include a second flow path integration hole 122.

The second flow path integration holes 122 may be respectively formed in both ends of the second flow path 121 and may be integrated with and connected to multiple channels formed in the second flow path 121 and configured for the second fluid to pass therethrough.

The second fluid supply hole 123 and the second fluid discharge hole 124 may be respectively located adjacent to the second flow path integration holes 122 respectively located in both ends of the second flow path 121.

Meanwhile, the first plate 110 may have second fluid through-holes 117 formed to pass therethrough and respectively provided at locations corresponding to the second fluid supply hole 123 and the second fluid discharge hole 124. Here, each of the second fluid through-holes 117 allows the second fluid to pass therethrough in the stacked direction of the first plate 110 and the second plate 120.

In this case, the second flow path integration hole 122 adjacent to the second fluid supply hole 123 may be overlapped with and connected to the second fluid supply hole 123 via the second fluid through-hole 117 in a state in which the first plate 110 is stacked on the second plate 120, and the second flow path integration hole 122 adjacent to the second fluid discharge hole 124 may be overlapped with and connected to the second fluid discharge hole 124 via the second fluid through-hole 117, thereby forming an interlayer connection part 117a.

For example, the second fluid supplied through the second fluid supply hole 123 may enter the second flow path 121 through the second flow path integration hole 122 via the interlayer connection part 117a formed in the second fluid through-hole 117 in the first plate 110, and the second fluid flowing through the second flow path 121 may be discharged from the second fluid discharge hole 124 through the second flow path integration hole 122 via the interlayer connection part 117a formed in the second fluid through-hole 117 in the first plate 110.

The fluid supplied into the second fluid supply hole 123 flows through a space between the layers of the first plate 110 and the second plate 120 and enters the second flow path 121, and the fluid that has passed through the second flow path 121 flows through a space between the layers of the first plate 110 and the second plate 120 and is discharged through the second fluid discharge hole 124, thereby making it possible not only to supply a large amount of the second fluid to the second flow path 121, but also to maximally reduce heat loss caused by the second fluid that is not able to enter the second flow path.

In addition, the second flow path integration hole 122 may include an integration hole reinforcing part 122a.

The integration hole reinforcing part 122a is formed to protrude toward the inside of the second flow path integration hole 122, and the first plate 110 and the integration hole reinforcing part 122a are bonded to each other, thereby not only reinforcing rigidity of the second flow path integration hole 122 that is formed to have a relatively large size so as to allow a large amount of the second fluid to flow through the second flow path 121, but also improving durability thereof.

In this case, since the integration hole reinforcing part 122a forms a shape similar to a column inside the second flow path integration hole 122 when bonded to the first plate 110, the size of the second flow path integration hole 122 may be made large so as to allow a large amount of the second fluid to pass therethrough.

The first plate 110 may have interlayer through-holes 118 respectively formed at locations corresponding to the second flow path integration holes 122 respectively located in both ends of the second flow path 121 and configured to respectively supply the second fluid into the second flow path integration holes 122 located in directly adjacent another layer without passing through the second fluid supply hole 123 or the second fluid discharge hole 124.

Here, the interlayer through-hole 118 supplies the second fluid to the second flow path integration hole 122 in the second plate 120 located on the directly adjacent layer without passing through the second fluid supply hole 123 or the second fluid discharge hole 124, thereby providing various forms of paths configured for the second fluid to enter the second flow path 121. In this manner, uniformity of the temperature for heat exchange may be improved.

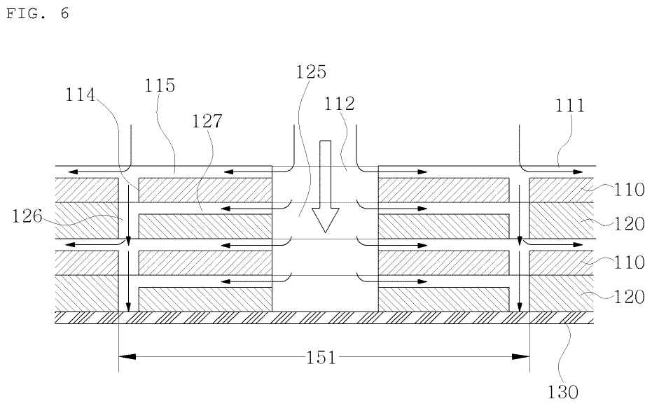

As shown in FIGS. 4 and 6, the second plate 120 may include a first fluid through-hole 125, a communication integration hole 126, and the communication dispersion part 127.

The first fluid through-holes 125 are formed to penetrate the second plate 120 and are respectively provided at locations corresponding to the second fluid supply hole 123 and the second fluid discharge hole 124 in the second plate 120. Accordingly, the second fluid supplied into the second fluid supply hole 123 in the second plate 120 may pass through the first plate 110 and may flow into the second fluid supply hole 123 of the adjacent second plate 120. Then, the second fluid discharged through the second fluid discharge hole 124 may pass through the first plate 110 and may flow into the second fluid discharge hole 124 in the adjacent second plate 120.

The communication integration hole 126 may be formed to penetrate the second plate 120 and may be located around the first fluid through-hole 125, and the communication integration hole 126 may partially overlap the first flow path integration hole 114 in the first plate 110,

Accordingly, the first fluid in the first flow path integration hole 114 may directly flow into the first flow path integration hole 114 in the adjacent first plate 110 through the communication integration hole 126 without passing through the first fluid supply hole 112 or the first fluid discharge hole 113.

The communication integration hole 126 may be formed around a part of the circumference of the first fluid through-hole 125. Further, the communication integration hole 126 may be formed to have an arc shape on the concentric circle of the first fluid through-hole 125.

Here, the communication integration hole 126 may be formed to be located in a direction opposite to a direction in which the first flow path integration hole 114 is located with respect to the first fluid supply hole 112 or the first fluid discharge hole 113 such that, when the first fluid flows through a space between the layers of the first plate 110 and the second plate 120, the first fluid may alternately flow through one side and the other of the first fluid supply hole 112 or the first fluid discharge hole 113.

Here, the communication integration hole 126 and the first flow path integration hole 114 are alternately located on one side and the other side of the first fluid discharge hole 113 or the first fluid supply hole 112, thereby allowing the first fluid to alternately flow through the one side and the other side. Accordingly, the first fluid may be dispersed to supply a larger amount of the first fluid, and the first fluid may bond the circumferential portions of the communication integration hole 126 and the first flow path integration hole 114 while flowing therethrough, thereby improving durability against the pressure of a high-pressure first fluid.

In this case, the first plate 110 and the second plate 120 may be bonded to each other by diffusion bonding, or by welding or soldering.

The communication dispersion part 127 may disperse the first fluid passing through the first fluid through-hole 125 so as to supply the dispersed first fluid to the communication integration hole 126.

Similarly to the first fluid dispersion part 115 formed on the first plate 110, the communication dispersion part 127 may be configured to include a circumferential dispersion flow path 127a, an inner connection flow path 127b, and an outer connection flow path 127c. Here, the circumferential dispersion flow path 127a may be formed to have a groove located between the first fluid through-hole 125 and the communication integration hole 126. A plurality of inner connection flow paths 127b may be radially connected to the first fluid through-hole 125 in the form of a straight groove from the inner circumference of the circumferential dispersion flow path 127a. A plurality of outer connection flow paths 127c may be connected to the communication integration hole 126 in the form of a straight groove from the outer circumference of the circumferential dispersion flow path 127a.

The first fluid in the first fluid through-hole 125 may flow to the circumferential dispersion flow path 127a through the inner connection flow path 127b. The first fluid of the circumferential dispersion flow path 127a may flow into the communication integration hole 126 through the outer connection flow path 127c and may flow into the first flow path integration hole 114 in the first plate 110 overlapping the second plate 120, or the first fluid located in the communication integration hole 126 may flow into the first fluid through-hole 125 by sequentially flowing through the outer connection flow path 127c, the circumferential dispersion flow path 127a, and the inner connection flow path 127b.

In the embodiment, the communication dispersion parts 127 are respectively formed in the first fluid through-hole 125 corresponding to the first fluid supply hole 112 and the first fluid through-hole 125 corresponding to the first fluid discharge hole 113, but the present invention is not limited thereto. The communication dispersion part 127 may be formed in only one of the two holes.

The second plate 120 may also have a weight reduction hole formed to penetrate an unused portion of the second plate 120 so as to reduce the weight of the second plate 120, and the weight reduction hole may be formed to have a size and a location corresponding to the weight reduction hole formed in the first plate 110.

As shown in FIG. 1 and FIG. 6, the printed-circuit-type heat exchanger 100 having improved durability according to the embodiment of the present invention may include an end plate 130 and a header plate 140.

The end plate 130 may overlap the first plate 110 or the second plate 120 located on one outermost side of a plurality of first plates 110 and second plates 120 alternately stacked on each other and may seal and close holes formed to penetrate the first plates 110 and the second plates 120 stacked on each other. Examples of the above-mentioned holes include the first fluid supply hole 112, the first fluid discharge hole 113, the second fluid through-hole 117, the weight reduction holes 116a and 128a, the interlayer through-hole 118, the second fluid supply hole 123, the second fluid through-hole 117, the first fluid through-hole 125, the communication integration hole 126, and the like.

The end plate 130 may have a size and a shape corresponding to the first plate 110 and the second plate 120. Further, the end plate 130 may be formed of a material having resistance to the first fluid or the second fluid.

The header plate 140 may overlap the first plate 110 or the second plate 120 located on the other outermost side of the plurality of first plates 110 and second plates 120 alternately stacked on each other. That is, the other outermost side on which the header plate 140 is provided is located opposite to the one outermost side on which the end plate 130 is provided.

The header plate 140 may be formed of a first fluid supply pipe part 141 connected to a supply pipe that supplies the first fluid to the first fluid supply hole 112, a first fluid discharge pipe part 142 connected to a discharge pipe that discharges the first fluid discharged from the first fluid discharge hole to the outside, a second fluid supply pipe part 143 connected to a supply pipe that supplies the second fluid to the second fluid supply hole 123, and a second fluid discharge pipe part 144 connected to a discharge pipe that discharges the second fluid discharged from the second fluid discharge hole to the outside.

In this case, a part of the first fluid supply pipe part 141, the first fluid discharge pipe part 142, the second fluid supply pipe part 143, and the second fluid discharge pipe part 144 may be formed in the header plate 140, and the remaining parts may be formed in the end plate 130.

Meanwhile, the end plate 130 and the header plate 140 may be respectively bonded to and stacked on one outermost side and the other outermost side of the stacked first and second plates in a state in which a plurality of first plates 110 and a plurality of second plates 120 are alternately stacked on each other, and diffusion bonding may be used for a bonding process.

In this case, the communication dispersion part 127 or the first fluid dispersion part 115 of the first plate 110 or the second plate 120 which directly overlaps the end plate 130 or the header plate 140 is bonded to the end plate or the head plate. Accordingly, even if a high-pressure first fluid is supplied, it is possible to prevent the end plate 130 or the header plate 140 from expanding due to the pressure of the first fluid, thereby improving durability of the end plate or the header plate.

In this manner, since the communication dispersion part 127 located around the first fluid through-hole 125 or the first fluid dispersion part 115 located around the first fluid supply hole 112 is bonded to the end plate 130 or the header plate 140, a mutual bonding area is increased such that, even if a high-pressure first fluid is supplied into the first fluid supply hole 112, deformation of the end plate 130 or the header plate 140 may be prevented.

The actions and effects of each configuration described above will be described.

The printed-circuit-type heat exchanger 100 having improved durability according to the embodiment of the present invention has the first fluid supply hole 112 formed to penetrate the first plate 110 and configured for the first fluid to be introduced thereinto, and the first fluid discharge hole 113 formed to penetrate the first plate 110 and configured for the introduced first fluid to be discharged therethrough.

The first flow path 111 having a zigzag curved shape is provided between the first fluid supply hole 112 and the first fluid discharge hole 113 and is configured for the first fluid to pass therethrough for heat exchange, and the first flow path integration holes 114 are respectively formed in both ends of the first flow path 111, which are respectively located close to the first fluid supply hole 112 and the first fluid discharge hole 113.

The channels of the first flow path 111 are integrally connected to each of the first flow path integration holes 114, and each of the first flow path integration holes 114 is formed to penetrate the first plate 110.

The thermal insulation part 119 is formed to penetrate a portion between the first direction part 111a and the second direction part 111b respectively having different first fluid flow directions and is configured to prevent heat transfer between the first direction part 111a and the second direction part 111b. Further, the divided thermal insulation parts 119 are connected to each other by the connection reinforcing part 119a so as to prevent deterioration in durability due to the thermal insulation part 119.

The first flow path integration hole 114 located in one end of the first flow path 111 is disposed adjacent to the first fluid supply hole 112, and the first flow path integration hole 114 located in the other end of the first flow path 111 is disposed adjacent to t t fluid discharge hole 113. Further, the first fluid dispersion parts 115 configured to disperse the first fluid are respectively formed at a portion between the first fluid supply hole 112 located in one end of the first flow path 111 and the first flow path integration hole 114 adjacent thereto and a portion between the first fluid discharge hole 113 located in the other end of the first flow path 111 and the first flow path integration hole 114 adjacent thereto.

The rod installation hole 116 is formed to penetrate each corner of the first plate 110, and the first plate 110 includes the second fluid through-holes 117 configured to allow the second fluid to pass through a space between the layers of the first and second plates, and respectively formed at a location corresponding to the second fluid supply hole 123 in the second plate 120 and a location corresponding to the second fluid discharge hole 124 in the second plate 120.

The second fluid through-hole 117 includes the interlayer connection part 117a formed to extend from the second fluid through-hole 117 so as to overlap the second flow path integration hole 122, thereby connecting the fluid introduced into the second fluid through-hole 117 to the second flow path integration hole 122 in the second plate 120.

The first plate 110 has the interlayer through-hole 118 formed at a location corresponding to the second flow path integration hole 122 in the second plate 120 and configured for the second fluid supplied into the second flow path integration hole 122 to pass through the first plate 110.

The first plate 110 has the weight reduction hole 116a formed to pass therethrough so as to reduce the weight of the first plate 110. Additionally, the first plate 110 has the rod installation hole 116 formed in each corner thereof and configured for each fixing rod to pass therethrough so as to fix the first plates 110 and the second plates 120 alternately stacked on each other.

The second plate 120 has the second fluid supply hole 123 formed to pass through the second plate and configured for the second fluid to be supplied through the second fluid supply hole. Further, the second plate 120 has the second fluid discharge hole 124 formed to pass through the second plate in a state of being spaced apart from the second fluid supply hole 123 and configured for the second fluid to be discharged through second fluid discharge hole. Here, the second flow path 121 configured to allow the second fluid to pass therethrough is formed to have a zigzag shape between the second fluid supply hole 123 and the second fluid discharge hole 124.

The second flow path 121 may have the second flow path integration holes 122 respectively located in both ends thereof and configured for the second fluid to be dispersed and supplied to each channel of the second flow path 121.

The thermal insulation part 129 may be formed between the first direction part 121a and the second direction part 121b respectively having different fluid flow directions in the second flow path 121 so as to prevent heat transfer between the first direction part 121a and the second direction part 121b, and the connection reinforcing part 129a may be formed between the thermal insulation parts 129 to reinforce rigidity.

The second plate 120 may have the first fluid through-holes 125 formed to pass therethrough, respectively provided at locations respectively corresponding to the first fluid supply hole 112 and the first fluid discharge hole 113, and configured for the first fluid to pass therethrough. The communication integration holes 126 are respectively formed to penetrate the circumferences of the first fluid through-holes 125 and are configured to disperse the first fluid. Further, the communication dispersion parts 127 are formed between the respective communication integration holes 126 and the respective first fluid through-holes 125. Here, the communication dispersion parts 127 are configured to disperse the fluid in the respective first fluid through-holes 125 and provide the dispersed fluid to the respective communication integration holes 126, or to collect the fluid in the respective communication integration holes 126 and supply the collected fluid to the respective first fluid through-holes 125.

The second plate 120 has the weight reduction hole 128a formed to pass therethrough and configured to reduce the weight of the second plate 120. Further, the second plate 120 has the rod installation hole 128 formed to pass therethrough at a location corresponding to the rod installation hole 116 in the first plate 110 and configured for a fixing rod to pass therethrough so as to be inserted thereinto.

The end plate 130 may overlap the first plate 110 or the second plate 120 located on one outermost side of the first plates 110 and the second plates 120 alternately stacked on each other, thereby preventing the first fluid and the second fluid from flowing out to the outside, and the header plate 140 may overlap the first plate 110 or the second plate 120 located on the other outermost side thereof opposite to the one outermost side on which the end plate 130 is located.

As necessary, the header plate 140 may be formed of the fluid supply pipe part 141 configured to supply the first fluid to the first fluid supply hole 112, the first fluid discharge pipe part 142 configured to discharge the first fluid discharged through the first fluid discharge hole 113 to the outside, the second fluid supply pipe part 143 configured to supply the second fluid to the second fluid supply hole 123, and the second fluid discharge pipe part 144 configured to discharge the second fluid discharged through the second fluid discharge hole 124 to the outside.

In the printed-circuit-type heat exchanger 100 having improved durability according to the embodiment of the present invention configured as described above, the first plates 110 and the second plates 120 are alternately stacked on each other, the end plate 130 is stacked on the first plate 110 or the second plate 120 located on one outermost side of the alternately stacked first and second plates, and the header plate 140 is stacked on the first plate 110 or the second plate 120 located on the other outermost side thereof.

In this state, in order to bond the first plates 110 and the second plates 120 to each other, for example, a press or an isostatic pressing device is used to press the first plates 110 and the second plates 120 and to diffusion-bond the same.

When the first plates 110 and the second plates 120 are bonded to each other through diffusion bonding, diffusion bonding is first performed in a state in which the header plate 140 is not stacked on the first plate or the second plate. Thereafter, the header plate 140 may be stacked thereon and bonded thereto. Alternatively, after both the end plate 130 and the header plate 140 are stacked on the first and second plates, diffusion bonding may be performed.

After the first plates 110 and the second plates 120 are bonded to each other, the alternately stacked first and second plates 110 and 120 are fixed to each other in such a manner that a fixing rod penetrates the rod installation holes 116 and 128 so as to be inserted thereinto and then is fastened by a nut.

Of course, the fixing rod may fix the first plates 110 and the second plates 120 alternately stacked on each other by penetrating the end plate 130 and the header plate 140.

Meanwhile, when the first plates 110 and the second plates 120 are stacked on each other, a first fluid supply passage 151 configured for the first fluid to be supplied therethrough is formed through the alternately arranged first fluid supply holes 112 and first fluid through-holes 125 in the stacked direction of the first plates 110 and the second plates 120. Further, a first fluid discharge passage 152 configured for the first fluid to be discharged therefrom is formed through the alternately arranged first fluid discharge holes 113 and first fluid through-holes 125 corresponding thereto in the stacked direction.

In this case, the first fluid supply passage 151 is formed in such a manner that the first fluid dispersion part 115 located around the first fluid supply hole 112 is bonded to the communication dispersion part 127, and the first flow path integration hole 114 and the communication integration hole 126 are alternately formed in the stacked direction around the first fluid dispersion part 115 and the communication dispersion part 127 bonded to each other.

Further, the first fluid discharge passage 152 is formed in such a manner that the first fluid dispersion part 115 located around the first fluid discharge hole is bonded to the communication dispersion part 127, and the first flow path integration hole 114 and the communication integration hole are alternately formed in the stacked direction around the first fluid dispersion part 115 and the communication dispersion part bonded to each other.

In this manner, the first fluid supply passage 151 and the first fluid discharge passage 152 may improve durability against a high-pressure first fluid because the first fluid supply hole 112 and the first fluid discharge hole 113 are located in the form of columns in the respective passages.

Additionally, a second fluid supply passage 153 configured for the second fluid to be supplied therethrough is formed through the alternately arranged second fluid supply holes 123 and second fluid through-holes 117 corresponding thereto in the stacked direction. Further, a second fluid discharge passage 154 configured for the second fluid to be discharged therefrom is formed through the alternately arranged second fluid discharge holes 124 and the second fluid through-holes 117 corresponding thereto in the stacked direction.

In the printed-circuit-type heat exchanger 100 having improved durability according to the embodiment of the present invention configured as described above, when the first fluid is supplied through the first fluid supply pipe part 141 formed in the header plate 140, the first fluid is introduced into the first fluid supply passage 151 formed of the first fluid supply hole 112 and the first fluid through-hole 125, and the first fluid introduced into the first fluid supply passage 151 flows from the first fluid supply hole 112 formed in each first plate 110 to the first flow path integration hole 114 connected to one end of the first flow path 111 through the first fluid dispersion part 115 (refer to FIG. 4).

A part of the first fluid flowing into the first flow path integration hole 114 flows into the first flow path integration holes 114 respectively formed in the other first plates 110 respectively located thereabove and therebelow through the communication integration hole 126 formed in the second plate 120. In this manner, a part of the first fluid is supplied while flowing through a space between the layers of the first plate 110 and the second plate 120. Here, the remaining first fluid is dispersed from the first flow path integration hole 114 to each channel of the first flow path 111 and enters the first flow path 111, and the first fluid flowing through the first flow path 111 is discharged through the first flow path integration hole 114 located in the other end of the first flow path 111.

Of course, a part of the first fluid passing through the first flow path integration hole 114 may be dispersed through the communication dispersion part 127 so as to be supplied into the first flow path integration hole 114 in the stacked first plate 110 through the communication integration hole 126.

Meanwhile, the first fluid flowing through the first flow path 111 sequentially flows through the first direction part 111a and the second direction part 111b respectively having different first fluid flow directions. In this case, the thermal insulation part 119 is formed to penetrate the first plate and is located between the first direction part 111a and the second direction part 111b so as to block heat transfer therebetween, thereby making it possible not only to prevent temperature changes of the first fluid flowing through the first and second direction parts adjacent to each other, but also to prevent deterioration in heat exchange properties of the first fluid.

The first fluid flowing through the first flow path 111 exchanges heat with the second fluid and then is discharged through the first fluid discharge hole 113. Here, before the first fluid is discharged through the first fluid discharge hole 113, a part of the first fluid may flow into the communication integration hole in the second plate 120 through the first flow path integration hole 114 adjacent to the first fluid discharge hole 113.

The first fluid discharged through the first flow path integration hole 114 gathers and flows into the first fluid discharge hole 113 again through the first fluid dispersion part 115 and is discharged through the first fluid discharge passage 152, and the first fluid discharged through the first fluid discharge passage 152 is discharged to the outside through the first fluid discharge pipe part 142 formed in the end plate 130.

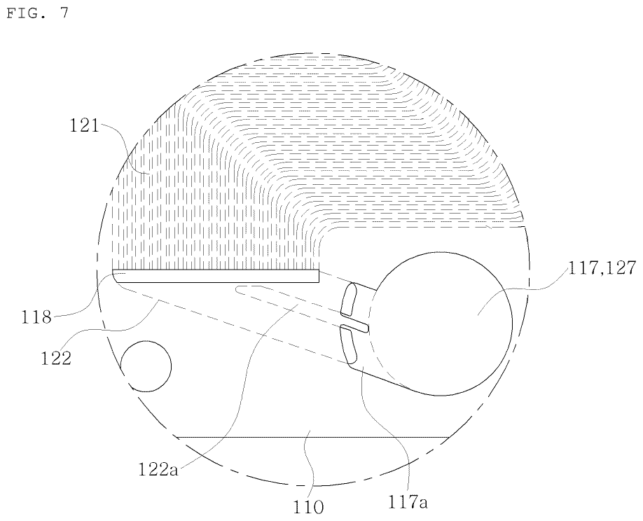

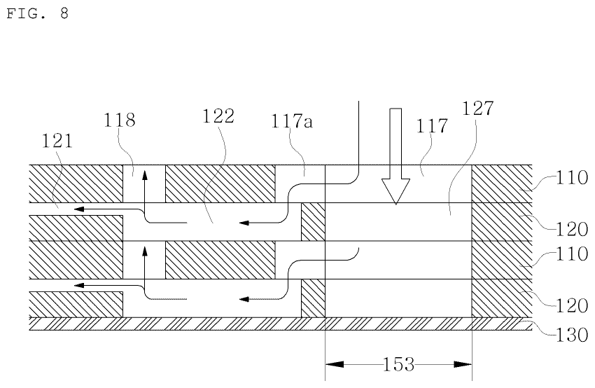

Meanwhile, the second fluid is supplied to the second fluid supply passage 153 formed of the second fluid supply hole 123 and the second fluid through-hole 117 through the second fluid supply pipe part 143 of the end plate 130. Further, the second fluid supplied into the second fluid supply hole 123 in the second plate 120 flows through a space between layers of the first and second plates and is supplied into the second fluid through-hole 117 in the first plate 110. Thereafter, the second fluid flows again into the second flow path integration hole 122 in the second plate 120 through the interlayer connection part 117a of the second fluid through-hole 117 so as to enter the second flow path 121 (refer to FIGS. 7 and 8).

In this case, the second fluid flows through a space between the layers of the second plate 120 and the first plate 110 and is supplied to the second flow path 121, so that the second fluid is dispersed, and a large amount of the second fluid is supplied to the second flow path 121, thereby preventing deterioration in heat exchange properties of the second fluid.

When the second fluid flowing through the second flow path 121 sequentially flows through the first direction part 121a and the second direction part 121b, the thermal insulation part 129 prevents heat transfer between the first direction part 121a and the second direction part 121b, thereby preventing deterioration in heat exchange properties of the second fluid.

Here, before the second fluid flows through the second flow path 121, a part of the second fluid introduced into the second flow path integration hole 122 is supplied to the second flow path 121, but the remaining second fluid may pass through the interlayer through-hole 118 formed in the first plate 110 and may be dispersed and introduced into the second flow path integration hole 122 in the second plate 120 located in a different layer.

The second fluid which has exchanged heat with the first fluid while flowing through the second flow path 121 is discharged from the second flow path integration hole 122 formed at a location corresponding to a direction in which the second fluid discharge hole 124 is located. Then, the second fluid discharged from the second flow path integration hole 122 flows into the second fluid through-hole 117 through the interlayer connection part 117a of the first plate 110 and passes through the second fluid discharge passage 154 formed of the second fluid discharge hole 124 and the second fluid through-hole 117. Then, the second fluid is discharged to the outside through the second fluid discharge pipe part 144 formed in the end plate 130.

A hydrogen storage device including the printed-circuit-type heat exchanger 100 having improved durability according to the embodiment of the present invention configured as described above may store hydrogen therein so as to charge a fuel cell using hydrogen or supply hydrogen to an internal combustion engine using hydrogen as fuel.

When the hydrogen storage device including a hydrogen tank stores hydrogen in the hydrogen tank, hydrogen may be stored in the hydrogen tank in a state in which the temperature of hydrogen is lowered by heat exchange between hydrogen and refrigerant through the printed-circuit-type heat exchanger 100, or hydrogen may be supplied to a fuel cell or an internal combustion engine in a state in which the temperature of hydrogen is lowered by heat exchange between hydrogen stored in the hydrogen tank and refrigerant.

Additionally, the printed-circuit-type heat exchanger 100 of the embodiment may also be used to supply refrigerant to the hydrogen tank in order to maintain a preset temperature of hydrogen stored in the hydrogen tank.

Hereinafter, a hydrogen compression device including the printed-circuit-type heat exchanger 100 having improved durability according to the embodiment of the present invention will be described.

Here, the hydrogen compression device including the printed-circuit-type heat exchanger 100 having improved durability according to the embodiment of the present invention may include a compressor configured to compress hydrogen.

The compressor may compress hydrogen cooled through the printed-circuit-type heat exchanger 100, or may compress hydrogen through the compressor in advance and then may supply the compressed hydrogen to the printed-circuit-type heat exchanger 100 so as to cool the compressed hydrogen.

The hydrogen compressed in the compressor may be supplied to a hydrogen tank or may be sent to a fuel cell using hydrogen or a hydrogen internal combustion engine using hydrogen as fuel.

The compressor may compress hydrogen by mechanical driving such as a piston or may compress hydrogen by hydraulic pressure such as a diaphragm or bellows. Various types of known compressors may be employed as the compressor.

Therefore, the hydrogen storage device and the hydrogen compression device including the printed-circuit-type heat exchanger 100 having improved durability according to the embodiment of the present invention may disperse the first fluid introduced into the first fluid supply hole 112 through the first fluid dispersion part 115 and may supply the dispersed first fluid to the first flow path integration hole 114 so as to increase an area for supplying the first fluid, thereby increasing the supply amount of the first fluid and improving heat exchange properties of the first fluid.

In addition, the first fluid dispersion part 115 and the communication dispersion part 127 are bonded to each other and are located in the center of the first fluid supply passage 151 through which the first fluid is supplied, thereby having an effect of providing a shape similar to a support column erected in the center of the first fluid supply passage 151. In this manner, it is possible to reliably withstand the pressure of the first fluid supply passage 151, leading to improvement in durability of the heat exchanger.

In addition, in comparison with the first fluid supply hole 112, the first flow path integration hole 114 connected to the first flow path 111 is formed to have a larger diameter than a diameter of the first fluid supply hole 112, so a larger number of channels of the first flow path 111 may be connected to the first flow path integration hole 114, thereby allowing the first fluid to quickly exchange heat with another fluid.

In addition, since the first fluid dispersion part 115 located between the first fluid supply hole 112 through which the first fluid passes and the first flow path integration hole 114 is bonded not only to the end plate 130 but also between the first plate 110 and the second plate 120 stacked on each other, durability may be improved and the thickness of the end plate 130 may be maximally reduced, thereby reducing the size of the printed-circuit-type heat exchanger 100.

In addition, the thermal insulation parts 119 and 129 are respectively formed in the first flow path 111 and the second flow path 121 so as to prevent heat transfer between the first fluid and the second fluid respectively flowing through the flow paths arranged adjacent to each other, thereby improving heat exchange properties of the first fluid and the second fluid.

Furthermore, the first plate 110 and the second plate 120 may be firmly bonded to each other through diffusion bonding, thereby preventing leakage of the first fluid or the second fluid between the first plate 110 and the second plate 120.

In addition, the weight reduction holes 116a and 128a may be respectively formed through the unused portions of the first plate 110 and the second plate 120, thereby reducing the weight of the printed-circuit-type heat exchanger 100.

Furthermore, the integration hole reinforcing part 122a is formed to protrude from the second flow path integration hole 122 connected to the second flow path 121 of the second plate 120. Then, the integration hole reinforcing part 122a is bonded to the first plate 110, thereby improving durability through increased rigidity of the second flow path integration hole 122. Additionally, while the second fluid of the second plate 120 flows through a space between the layers of the second plate 120 and the first plate 110 through the interlayer connection parts 117a in the respective second fluid through-holes 117 in the first plate 110, the second fluid flows into the second flow path integration holes 122 respectively corresponding to the second fluid supply hole 123 and the second fluid discharge hole 124. In this manner, a large amount of the second fluid may be reliably supplied.

Although embodiments of the present invention have been described above, the scope of the present invention is not limited to the disclosed embodiments, and it will be appreciated by those skilled in the art to which the present invention pertains that various modifications and improvements may be made to the embodiments without departing from the principles and spirit of the present invention, the scope of which is defined in the appended claims and equivalents thereto.

### DESCRIPTION OF REFERENCE NUMERALS

100: Printed-circuit-type heat exchanger 110: First plate
111: First flow path 111a, 121a: First direction part
111b, 121b: Second direction part 111c: Connection flow path part
112: First fluid supply hole 113: First fluid discharge hole
114: First flow path integration hole 115: First fluid dispersion part
115a, 127a: Circumferential dispersion flow path
115b, 127b: Inner connection flow path
115c, 127c: Outer connection flow path 116, 128: Rod installation hole
116a, 128a: Weight reduction hole 117: Second fluid through-hole
117a: Interlayer connection part 118: Interlayer through-hole
119, 129: Thermal insulation part 119a, 129a: Connection reinforcing part
120: Second plate 121: Second flow path
122: Second flow path integration hole 122a: Integration hole reinforcing part
123: Second fluid supply hole 124: Second fluid discharge hole
125: First fluid through-hole 126: Communication integration hole
127: Communication dispersion part 130: End plate
140: Header plate 141: First fluid supply pipe part
142: First fluid discharge pipe part 143: Second fluid supply pipe part
144: Second fluid discharge pipe part 151: First fluid supply passage
152: First fluid discharge passage 153: Second fluid supply passage
154: Second fluid discharge passage

1. A printed-circuit-type heat exchanger having improved durability, the printed-circuit-type heat exchanger comprising:
a first plate having a first flow path formed therein and configured for a first fluid to flow therethrough; and
a second plate overlapping the first plate, the second plate having a second flow path formed therein and configured for a second fluid to flow therethrough, wherein the first plate comprises:
a first fluid supply hole configured for the first fluid to be supplied therethrough to the first flow path;
a first fluid discharge hole configured for the first fluid passing through the first flow path to be discharged therefrom;
a first flow path integration hole located in one end or both ends of the first flow path, the first flow path integration hole being configured to integrally connect channels of the first flow path to each other so as to supply the first fluid to the first flow path or to discharge the first fluid from the first flow path; and
a first fluid dispersion part configured to connect the first flow path integration hole to the first fluid supply hole or the first fluid discharge hole formed at a location corresponding to the first flow path integration hole, the first fluid dispersion part being configured for the first fluid to be dispersed and moved therethrough.

2. The printed-circuit-type heat exchanger according to claim 1, wherein the first flow path integration hole is formed to have a larger diameter than a diameter of the first fluid supply hole or the first fluid discharge hole such that a large number of the channels of the first flow path are connected to the first fluid supply hole or the first fluid discharge hole.

3. The printed-circuit-type heat exchanger according to claim 1, wherein the second plate comprises a communication integration hole formed to pass therethrough, wherein the communication integration hole is formed at a location corresponding to the first flow path integration hole in a state of overlapping the first flow path integration hole so as to allow the first fluid in the first flow path integration hole to move through the second plate.

4. The printed-circuit-type heat exchanger according to claim 2, wherein first flow path integration hole and the communication integration hole are disposed in opposite directions with respect to the first fluid supply hole or the first fluid discharge hole such that, when the first fluid flows through the first plate and the second plate in a direction in which the first plate and the second plate are stacked on each other, the first fluid alternately flows through one side and the other side of the first fluid supply hole or the first fluid discharge hole.

5. The printed-circuit-type heat exchanger according to claim 2, wherein the second plate comprises:
first fluid through-holes respectively formed at locations corresponding to the first fluid supply hole and the first fluid discharge hole, the first fluid through-holes being configured for the first fluid to pass through the second plate in a direction in which the first plate and the second plate are stacked on each other; and
a communication dispersion part formed between the first fluid through-hole and the communication integration hole and configured to allow the first fluid to be dispersed and moved between the first fluid through-hole and the communication integration hole.

6. The printed-circuit-type heat exchanger according to claim 1, wherein the first fluid dispersion part comprises:
a circumferential dispersion flow path located between the first fluid supply hole and the flow path integration hole or between the first fluid discharge hole and the flow path integration hole, the circumferential dispersion flow path being formed to have a larger circumference than a circumference of the first fluid supply hole or the first fluid discharge hole;
an inner connection flow path configured to connect the circumferential dispersion flow path to the first fluid supply hole or the first fluid discharge hole corresponding to the circumferential distribution flow path; and
an outer connection flow path configured to connect the circumferential dispersion flow path to the flow path integration hole corresponding to the circumferential distribution flow path.

7. The printed-circuit-type heat exchanger according to claim 1, wherein the first flow path or the second flow path comprises:
a first direction part and a second direction part disposed adjacent to each other, the first and second direction parts respectively having different flow directions of the first fluid or the second fluid; and
a thermal insulation part formed to penetrate a portion located between the first direction part and the second direction part so as to block heat transfer therebetween.

8. The printed-circuit-type heat exchanger according to claim 7, wherein the thermal insulation part comprises a connection reinforcing part formed to cross the thermal insulation part so as to reinforce rigidity reduced by the thermal insulation part formed to penetrate the portion between the first direction part and the second direction part.

9. The printed-circuit-type heat exchanger according to claim 1, wherein the first plate and the second plate are fully bonded to each other by diffusion bonding.

10. The printed-circuit-type heat exchanger according to claim 1, wherein one of the first fluid and the second fluid is refrigerant, and the other contains hydrogen cooled by the refrigerant.

11. The printed-circuit-type heat exchanger according to claim 1, wherein the first flow path in the first plate or the second flow path in the second plate is formed by chemical etching or mechanical polishing.

12. The printed-circuit-type heat exchanger according to claim 1, comprising:
an end plate stacked on the first plate or the second plate located on an outermost side of the first plate and the second plate stacked on each other, the end plate sealing the fluid supply hole and the fluid discharge hole,
wherein the first fluid dispersion part is bonded to the end plate so as to improve durability of a portion of the end plate part, the portion corresponding to the first fluid supply hole or the first fluid discharge hole.

13. The printed-circuit-type exchanger heat according to claim 1, wherein the first plate or the second plate comprises a weight reduction hole for reduction in weight of the first plate or the second plate, the weight reduction hole being formed by perforating the first plate or the second plate.

14. The printed-circuit-type heat exchanger according to claim 1, wherein each of the first plate and the second plate stacked on each other comprises a rod installation hole formed therein and configured for a fixing rod to be inserted thereinto so as to fix the stacked first and second plates.

15. A printed-circuit-type heat exchanger having improved durability, the printed-circuit-type heat exchanger comprising:
a first plate having a first flow path formed therein and configured for a first fluid to flow therethrough; and
a second plate overlapping the first plate, the second plate having a second flow path formed therein and configured for a second fluid to flow therethrough,
wherein the second plate comprises:
second flow path integration holes connected to channels of the second flow path so as to communicate therewith;
a second fluid supply hole and a second fluid discharge hole respectively spaced apart from the second flow path integration holes respectively located in both ends of the second flow path, the second fluid supply hole being configured for the second fluid to be supplied therethrough, the second fluid discharge hole being configured for the second fluid to be discharged therethrough; and
integration hole reinforcing parts formed to protrude from the respective second flow path integration holes, the integration hole reinforcing parts being bonded to the first plate so as to reinforce rigidity reduced by formation of the second flow path integration holes, and
wherein the first plate comprises:
second fluid through-holes respectively formed at locations respectively corresponding to the second fluid supply hole and the second fluid discharge hole, each of the second fluid through-holes being configured for the second fluid to pass therethrough; and
interlayer connection parts formed to extend from the respective second fluid through-holes, wherein one of the interlayer connection parts is connected to the second flow path integration hole corresponding to the second fluid supply hole, and the other of the interlayer connection parts is connected to the second flow path integration hole corresponding to the second fluid discharge hole, thereby enabling a large amount of the second fluid to flow through a space between layers of the first and second plates.

16. A hydrogen storage device comprising a printed-circuit-type heat exchanger having improved durability, the hydrogen storage device comprising:
the printed-circuit-type heat exchanger having improved durability according to claim 1; and
a hydrogen tank configured to store hydrogen therein, the hydrogen being cooled by the printed-circuit-type heat exchanger, or to supply the stored hydrogen to the printed-circuit-type heat exchanger for cooling.

17. A hydrogen compression device comprising a printed-circuit-type heat exchanger having improved durability, the hydrogen compression device comprising:
the printed-circuit-type heat exchanger having improved durability according to claim 1; and
a compressor configured to receive hydrogen cooled through the printed-circuit-type heat exchanger and compress the cooled hydrogen, or to compress the hydrogen and supply the compressed hydrogen to the printed-circuit-type heat exchanger.
